(19) United States
(12) Patent Application Publication
(10) Pub. No.: US 2007/0265977 A1
(43) Pub. Date: Nov. 15, 2007

(54) Method and system for improved digital rights management

(76) Inventor: Chris Read, San Diego, CA (US)

Correspondence Address: WAGNER, MURABITO & HAO LLP;Third Floor, Two North Market Street, San Jose, CA, 95113, US

(21) Appl. No.: 11/433,112

(22) Filed: May 12, 2006

(51) Int. Cl. G06Q 99/00

(52) U.S. Cl. 705/59

(57) ABSTRACT

Embodiments of the present invention are directed to a method and system for managing rights associated with digital content. More specifically, embodiments provide an efficient digital rights management (DRM) mechanism for improved protection of and control over the use of digital content, which also reduces the adverse effect on the fair use rights of a purchaser when lending the content to a third party. In one embodiment, a first content segment is accessed. Thereafter, a second content segment is generated from the first content segment, wherein the second content segment is a reproduction of a portion of the first content segment. A plurality of rights associated with the first content segment are then limited upon activation of a license corresponding to the second content segment. Thereafter, the plurality of rights associated with the first content segment are restored upon deactivation of the license corresponding to the second content segment.

### FIELD OF THE INVENTION

Embodiments of the present invention are related to the field of digital rights management.

### BACKGROUND OF THE INVENTION

With the growing use and distribution of digital content over its analog counterpart, digital rights management (DRM) has become increasingly more important to artists and distributors of digital content. Whereas copies of analog content were generally inferior to the original, exact copies of digital content may be made with most any computer system. As such, many DRM mechanisms have been implemented to restrict use, modification, and/or copying of digital content. For example, attempts have been made to render content playable only in the presence of specific hardware. While this approach has failed given compatibility and ease-of-use issues, attempts to implement DRM mechanisms on read-only-memory media (e.g., DVD) have been more successful. Similarly, digital watermarking of content has also succeeded in reducing unauthorized use, modification, and copying.

However, despite attempts to protect and restrict access to digital content, schemes have been devised to circumvent them. And once DRM mechanisms are bypassed, full-quality reproductions may be extracted for access or use by unauthorized users who did not purchase the content. Moreover, networking and the internet exacerbate the problem by providing any computer user the means to make and share such unauthorized content. Therefore, it is not surprising that DRM proponents have pushed for increased protection of digital content.

Although increasing the strength of DRM mechanisms may reduce access to content by unauthorized users, such action may impinge on a legitimate purchaser's authorized rights. For example, while authorized use may permit a user to copy content for personal use or lend content to a friend, strong DRM may limit a purchaser's ability to exercise such rights.

### SUMMARY OF THE INVENTION

Accordingly, a need exists for a method and system to effectively enforce content licenses while respecting the authorized use of consumers. More specifically, a need exists to adjust the rights associated with digital content when such digital content is lent to a third party. Furthermore, a need exists to increase the rights of a party borrowing digital content while simultaneously decreasing the rights of a consumer lending such digital content. A need also exists for a mechanism to restore the rights associated with digital content to a consumer subsequent to lending the digital content to a third party. Embodiments of the present invention provide novel solutions to these needs and others as described below.

Embodiments of the present invention are directed to a method and system for managing rights associated with digital content. More specifically, embodiments provide an efficient digital rights management (DRM) mechanism for improved protection of and control over the use of digital content, which also reduces the adverse effect on the authorized use of a purchaser when lending the content to a third party. In one embodiment, a first content segment is accessed. Thereafter, a second content segment is generated from the first content segment, wherein the second content segment is a reproduction of a portion of the first content segment. A plurality of rights associated with the first content segment are then limited upon activation of a license corresponding to the second content segment. Thereafter, the plurality of rights associated with the first content segment are restored upon deactivation of the license corresponding to the second content segment.

Other embodiments include the above, and wherein the license corresponding to the second content segment permit playback and prevent copying of the second content segment. Additionally, the digital content may reside on a computer-usable medium or a memory of a portable computing device. And in another embodiment, a computer system enables instructions stored in a memory to be executed on a processor to implement a method in accordance with the previously-discussed embodiments.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows a computer-implemented process for managing rights associated with digital content when loaning a copy of the content in accordance with one embodiment of the present invention.

FIG. 2 shows a computer-implemented process for managing rights associated with digital content when loaning an original computer-usable medium containing the content in accordance with one embodiment of the present invention.

FIG. 3 shows a block diagram depicting the transfer of modifiable content from one device to another in accordance with one embodiment of the present invention.

FIG. 4 shows a block diagram depicting the transfer of content through the creation of a copy disk in accordance with one embodiment of the present invention.

FIG. 5 shows a block diagram depicting the transfer of non-modifiable content from one device to another in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing the terms such as “identifying,” “defining,” “determining,” “performing,” “processing,” “comparing,” “repeating,” “creating,” “modifying,” “assigning,” “moving,” “establishing,” “using,” “calculating,” “adding,” “accessing,” “generating,” “limiting,” “revoking,” “restoring,” “copying,” “activating,” “deactivating,” “lending,” “loaning,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### EMBODIMENTS OF THE INVENTION

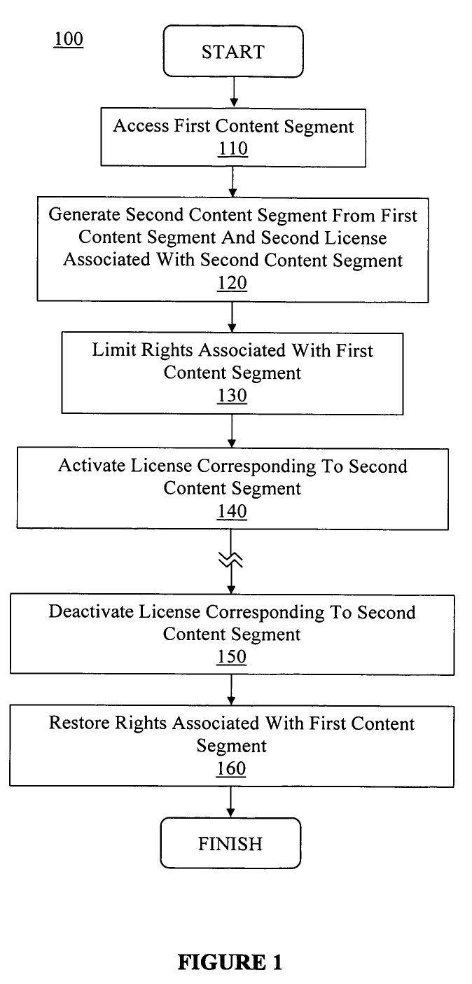

FIG. 1 shows computer-implemented process 100 for managing rights associated with digital content when loaning a copy of the content in accordance with one embodiment of the present invention. As shown in FIG. 1, step 110 involves accessing a first content segment. In one embodiment, the first content segment may be audio, video or audio/video content comprising media. The content may be stored on a computer-usable medium (e.g., a CD-ROM, DVD-ROM, or other physical media), or alternatively on a memory (e.g., a hard drive) of a portable computing device (e.g., a laptop, PDA, portable music/video player, etc.).

Accordingly, regardless of how the content accessed in step 110 is stored, the first content segment should be made available to a system or device executing process 100. In one embodiment, content stored on computer-usable medium may be made accessible by a user inserting the computer-usable media to the system or device performing process 100. Alternatively, content stored on a portable computing device may be made accessible by allowing the portable device to communicate with the system or device performing process 100. For example, a portable computing device may be physically connected (e.g., by a network connection, USB cable, etc.). Alternatively, a wireless connection may enable communication with a computer system performing process 100. And in another embodiment, where the portable device containing the content is capable of performing process 100, internal circuitry or other physical connection may couple a plurality of devices or components storing the content to a plurality of devices or components performing process 100.

After the first content segment is accessed, a second content segment may be generated from the first content segment in step 120, where a second license is associated with the second content segment. The second content segment may be either a complete or partial reproduction of the first segment. As such, in one embodiment, a system or device accessing the content in step 110 may reproduce selected portions of the first content segment. For example, where licensing data to be modified is included within the first content segment, the portion or portions not pertaining to the license may not require reproduction since a modified license may be written to the content at a later time. Alternatively, a purchaser of content may decide to loan or transfer only a part of the content (e.g., 2 tracks of a CD). Accordingly, only the portion of the content to be loaned or transferred need be reproduced in step 120 to form the second content segment.

Since step 120 involves the reproduction of portions of content that may be protected by patent, copyright, license or other forms of intellectual property, it should be appreciated that the system or device performing step 120 does so in a manner consistent with license terms or laws protecting any intellectual property embodied in the content or computer-usable medium. Moreover, it should be appreciated that any system or device performing step 120 has sufficient privileges to execute commands necessary to generate the second content segment.

As shown in FIG. 1, step 130 involves limiting the rights associated with the first content segment. In one embodiment, step 130 may be performed prior to lending content (e.g., on a separate “copy” disk containing the second content segment, via file transfer after generating the second content segment, etc.) to a user who did not purchase the content. Accordingly, the rights given to the purchaser of the content may be restricted upon agreeing to lend the content to another user, which conforms with accepted fair-use analogies, such as lending a book. After lending a book, the lender may no longer read (e.g., use) the book since it is in the borrower's possession until returned. Similarly, in one embodiment, the rights of a purchaser of digital content (e.g., to use the content) may be limited upon lending the content. As such, the right of the lender to use the content is given up in exchange for the borrower's use. In other embodiments, rights other than use (e.g., the right to modify, copy, transfer, etc.) may be limited in step 130.

As shown in FIG. 1, step 140 involves activating a license corresponding to the second content segment, where the second license may be embodied on the same computer-usable medium as the second content segment (e.g., CD-ROM, hard disk drive, etc.). Once the second license is activated, a user of the second content segment may exercise any rights granted by the license. For example, in one embodiment, a user of the second content segment (e.g., a user borrowing the content from the purchaser) may be limited to playing the content, but not allowed to modify, copy or transfer the content. In another embodiment, a greater or fewer number of rights may be granted to a user of the second content segment.

Although step 140 is depicted in FIG. 1 as occurring subsequent to step 130, it should be appreciated that in other embodiments steps 130 and 140 may occur in a different order (e.g., simultaneously, activation of the license for the second content segment before the rights associated with the first content segment are limited, etc.). Additionally, steps 130 and 140 may be performed before or after content is transferred or loaned. As such, the order of steps 130 and 140 is less significant than the relationship of the rights of the first and second content segments, where the relationship enables the use of strong DRM mechanisms while respecting a purchaser's fair use rights. For example, the rights associated with a first content segment may be inversely related to the rights associated with a second content segment. Thus, in one embodiment, when the rights associated with one content segment increase, the other may decrease, or vice versa.

As shown in FIG. 1, step 150 involves deactivating a license corresponding to the second content segment after some event or time period. License deactivation may occur through managing the license terms such that the license is no longer active (e.g., when the content or computer-usable medium embodying the content is returned to the lender, upon reaching a time or access limit, etc.). Alternatively, license deactivation may occur automatically by the expiration of a predetermined time period, a predetermined time or number of accesses to the content (e.g., determined prior to or simultaneously with the activation of the license in step 140). As such, once the time or access limit has been reached, the license corresponding to the second content segment may automatically deactivate.

Once the license is deactivated, a user of the second content segment may not longer exercise rights granted by the license. Thereafter, in one embodiment, the rights associated with the first content segment (e.g., those limited in step 130) may be restored in step 160. As such, the user of the first content segment (e.g., the purchaser) may resume copying, transferring, using, etc. in accordance with the terms of the content license and the intellectual property laws.

As discussed above with respect to steps 130 and 140, steps 150 and 160 may be performed in a different order in other embodiments. Additionally, steps 150 and 160 may be performed before or after content is returned to the lender. Again, the order and timing of performance is not as important as maintaining the relationship (e.g., inverse) of rights corresponding to the first and second content segments.

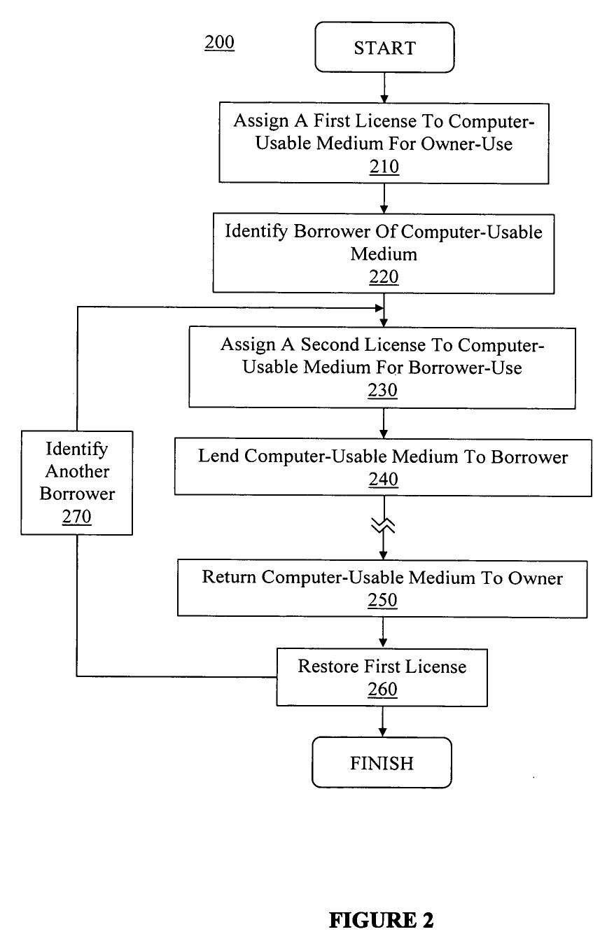

FIG. 2 shows computer-implemented process 200 for managing rights associated with digital content when loaning an original computer-usable medium containing the content in accordance with one embodiment of the present invention. As shown in FIG. 2, step 210 involves assigning a first license to computer-usable medium for use by a purchaser. As such, the purchaser of the computer-usable medium may exercise certain rights (e.g., playback, copy, transfer, etc.) with respect to the content embodied in a computer-usable medium.

In one embodiment, the computer-usable medium may be modifiable such that the license (e.g., embodied in the computer-usable medium) may be assigned in step 210 through writing or modifying data on the computer-usable medium. The assignment of the first license may be performed by a computer system or other device. In one embodiment, a computer system used by the purchaser may assign the license (e.g., when the computer-usable medium is inserted into the system for the first time). In another embodiment, a third-party system or server may assign the license to the purchaser after communicating with a system or device capable of accessing the computer-usable medium.

In another embodiment, the computer-usable medium may not be modifiable, such that a system or device may be required to manage the licenses associated with the content embodied in the computer-usable medium (e.g., assigning a first license in step 210). The system or device may be implemented as a centralized server in communication with other systems or devices capable of reading the computer-usable medium. As such, license terms may be accurately tracked and updated to reduce the possibility of users obtaining more rights than intended. For example, a borrowing user given the right to merely playback content on a computer-usable medium may be able to copy the content for personal use if misidentified as the purchaser, where copying for personal use is a right given to the purchaser. Alternatively, the system or device may reside with a computer system of a user. As such, the system or device may track the license terms, rights and/or privileges of the computer-usable medium accessed by the system or device, then communicate with another system or device accessing the same computer-usable medium at another time to perform the management of the licenses.

After a first license is assigned to a computer-usable medium, a borrower of the computer-usable medium may be identified in step 220. The borrower may be any user who is not a current owner of the computer-usable medium, regardless of the duration of the loan.

Thereafter, a second license is assigned to the computer-usable medium for use by a borrower in step 230. The second license may have fewer rights than the first license (e.g., limited to playback of the content), thereby limiting the rights associated with the original computer-usable medium when in the borrower's possession. Additionally, the second license may be assigned analogously to the first license described above in step 210. Accordingly, the second license may be represented as a separate data block from the first license, either on the computer-usable medium or in a system or device designed to manage the licenses associated with the computer-usable medium. Alternatively, the second license may be represented as a modification to the first license, either on the computer-usable medium or in a system or device designed to manage the licenses associated with the computer-usable medium.

As shown in FIG. 2, step 240 involves lending the computer-usable medium to a borrower. Lending may include any transfer of the computer-usable medium to a person other than the owner, but shall not include a complete transfer of rights (e.g., by sale).

Although step 240 is depicted in FIG. 2 as occurring subsequent to step 230, it should be appreciated that in other embodiments steps 230 and 240 may occur in a different order (e.g., simultaneously, lending the computer-usable medium before the second license is assigned, etc.) As such, the second license may be assigned to the borrower at any time, but should occur before the borrower is able to access the content (e.g., after the borrower couples the computer-usable medium a system or device capable of assigning the second license, but before playback is allowed).

As shown in FIG. 2, step 250 involves returning the computer-usable medium to the owner. The computer-usable medium shall be deemed returned when a borrower can no longer access the content embodied within the computer-usable medium (e.g., when the second license is deactivated as discussed with respect to step 150 of FIG. 1). Thereafter, in step 260, the first license of the purchaser may be restored in any way and by any means discussed above with respect to steps 210 and 230. In restoring the first license, it should be understood that the second license shall be rendered invalid. As such, after the first license is restored, the purchaser shall enjoy all rights assigned in step 210 with respect to the computer-usable medium, whereas the borrower shall have no rights previously enjoyed under the second license.

In one embodiment, after the first license is restored in step 260, process 200 may terminate. Alternatively, another borrower may be identified in step 270 after restoring the first license. Thereafter, steps 230 through 260 may be repeated for the newly-identified borrower in step 270.

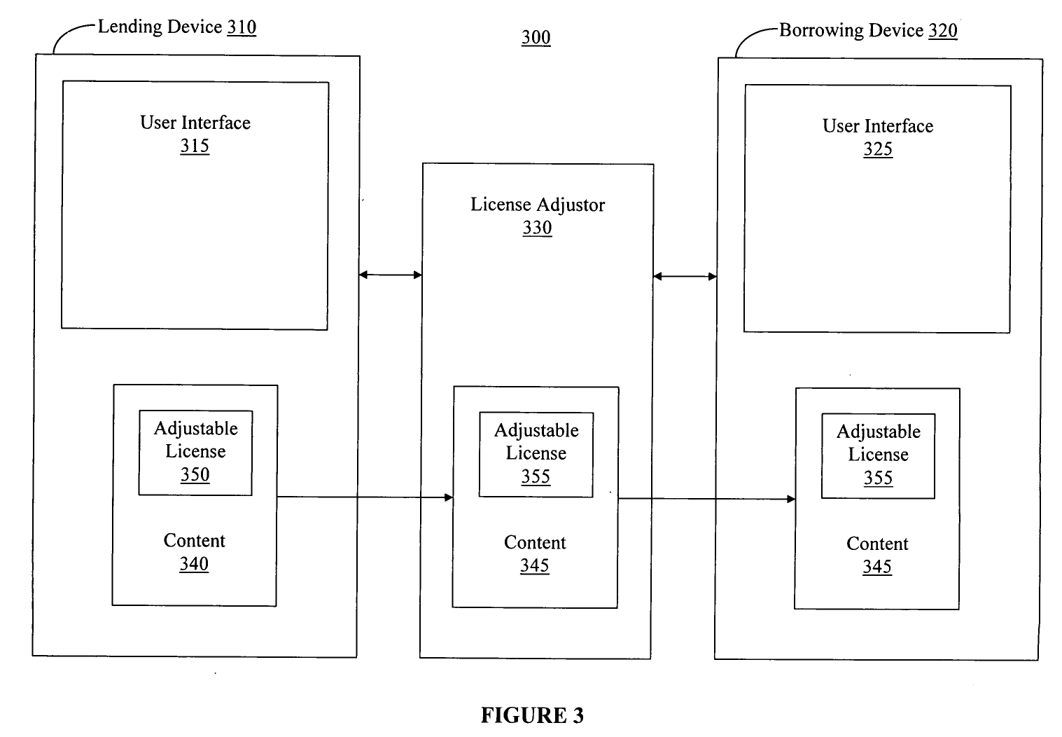

FIG. 3 shows block diagram 300 depicting the transfer of modifiable content from one device to another in accordance with one embodiment of the present invention. As shown in FIG. 3, lending device 310 may access content 340 in accordance with adjustable license 350. In one embodiment, content 340 and adjustable license 350 may be copied to produce content 345 and adjustable license 355. Thereafter, content 345 and adjustable license 355 may be transferred to license adjuster 330 where adjustable license 345 is adjusted to provide borrowing rights to borrowing device 320. Content 345 and adjustable license 355 may then be transferred to borrowing device 320. As such, license adjustor 330 may then transfer a copy of content 345 with an adjusted license to borrowing device 320.

Content 340 and content 345 may be any audio, video or audio/video content, which may be encoded and/or encrypted. As depicted in FIG. 3, the content may include an adjustable license. Alternatively, the license may be a separate data block which may be linked to the content through any well-known means (e.g., via address registers, etc.). As such, a transfer of the content may cause the adjustable license corresponding to the content to be transferred.

As shown in FIG. 3, lending device 310 and borrowing device 320 may be any computing system capable of accessing content (e.g. 340 and/or 345) including, but not limited to: a personal computer (e.g., desktop or laptop), personal digital assistant (PDA), portable music player, portable music/video player, cellular phone, pager, or the like. Lending and borrowing devices may be coupled to one another to allow transfer of content. For example, as shown in FIG. 3, lending device 310 and borrowing device 320 are coupled via license adjustor 330. However, in other embodiments, lending and borrowing devices may be alternatively coupled (e.g., directly, via a centralized license management system, via the internet, etc.). Additionally, lending device 310 and borrowing device 320 may include user interfaces (e.g., user interfaces 315 and 325) to allow content management including, but not limited to, content transfers. User interfaces of the lending and borrowing devices may comprise any well-known user interface (e.g., graphical user interface (GUI), command line interface, touch screen interface, voice-activated interface, menu-driven interface, manual switch, etc.).

License adjustor 330 may be any system or device capable of altering an adjustable license (e.g., 350 or 355) associated with content (e.g., 340 or 345). Although license adjustor 330 is depicted in FIG. 3 as a separate system or device, it is appreciated that license adjustor 330 may be integrated as a component or system within either lending device 310 or borrowing device 320. Accordingly, license adjustor 330 may be coupled to both a lending and borrowing device to oversee license management functions as well as content copying functions (e.g., as discussed above with respect to FIG. 1). As such, even if content is not copied within or at the direction of license adjustor 330, license adjustor 330 shall enable enforcement of licenses corresponding to content accessed by lending device 310 and/or borrowing device 320. Thus, such an implementation may encourage compliance with license terms to carry out strong DRM mechanisms, while effectively monitoring and managing license terms to enable lending of content in accordance with the fair use doctrine.

Upon initiating a transfer of content in accordance with block diagram 300 (e.g., via user interface 315 or 325), content may be transferred from lending device 310 to borrowing device 320 as described above. In the course of the transfer, adjustable license 350 may be adjusted into adjustable license 355 to allow playback by borrowing device 320, but prevent copying, modifying, or otherwise transferring the content (e.g., as described with respect to step 140 of FIG. 1). While the content is accessible to borrowing device 320, the rights associated with content 340 accessible by lending device 310 may be reduced (e.g., to prevent playback, copying, modifying, etc.) to maintain the balance between enforcement of DRM mechanisms and the fair use doctrine (e.g., as described with respect to step 130 of FIG. 1). The reduction of rights may be effectuated by license adjustor 330 communicating with lending device 310 to adjust the license associated with content 340 (e.g., adjustable license 350).

Once the content is no longer accessible to borrowing device 320 (e.g., the license to access the content has been deactivated as described with respect to step 150 of FIG. 1), the rights associated with content 340 given to lending device 310 (e.g., as a purchaser of the content) may be restored (e.g., as described above with respect to step 160). In the case where content 340 is transferred to borrowing device 320 such that access to content 340 is denied to lending device 310, the content may be returned (e.g., after adjusting the license to restore the lender's rights) to lending device 310 after the deactivation of the borrowing device's license. Alternatively, where a copy of the content is transferred such that the lending device may still access the content while the borrowing device may access the copy, license adjustor 330 may deactivate the borrower's license (e.g., where such deactivation would not occur automatically as described above with respect to FIG. 1) by communicating with the borrowing device and restore the rights associated with the lender's content by communicating with the lending device.

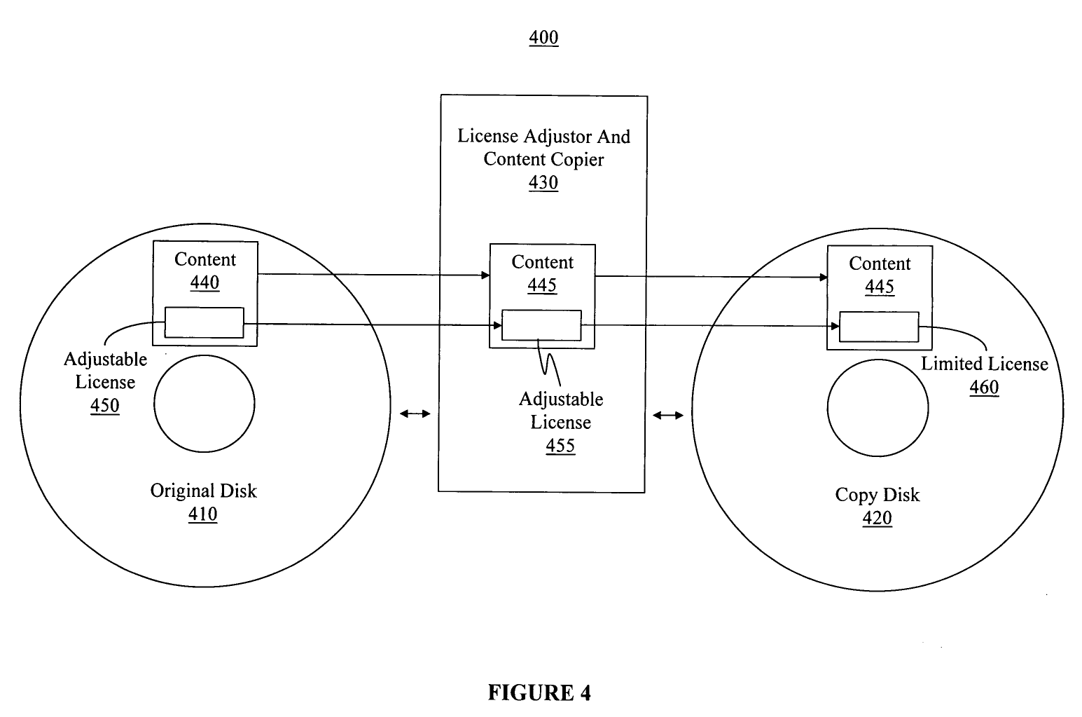

FIG. 4 shows block diagram 400 depicting the transfer of content through the creation of a copy disk in accordance with one embodiment of the present invention. As shown in FIG. 4, original disk 410 is computer-usable medium embodying content 440 and adjustable license 450. Content 440 and adjustable license 450 may be transferred to and copied by license adjustor and content copier 430 to produce content 445 and adjustable license 455. Thereafter, license adjustor and content copier 430 may modify adjustable license 455 to create limited license 460. Content 455 and limited license 460 may then be transferred to copy disk 420, where copy disk 420 is also computer-usable medium.

Content 440 and content 445 may be any audio, video or audio/video content, which may be encoded and/or encrypted. As depicted in FIG. 4, the content (e.g. 440) may include an adjustable license (e.g., 450). Alternatively, the license may be a separate data block which may be linked to the content through any well-known means (e.g., via address registers with a system accessing the computer-usable medium embodying the content, etc.). As such, a transfer of the content may cause the adjustable license corresponding to the content to be transferred.

License adjustor and content copier 430 may be any system or device capable of altering an adjustable license (e.g., 450 or 455) associated with content (e.g., 440 or 445). Although license adjustor 430 is depicted in FIG. 4 as a single system or device, it is appreciated that license adjustor and content copier 430 may comprise one or more systems or devices (e.g., one system or device to adjust licenses and another system or device to copy content). Accordingly, license adjustor and content copier 430 may be coupled to both an original disk and a copy disk to oversee license managing functions as well as content copying functions (e.g., as discussed above with respect to FIG. 1). As such, license adjustor and content copier 430 shall enable enforcement of licenses corresponding to content embodied within original disk 410 and copy disk 420. Thus, such an implementation may encourage compliance with license terms to carry out strong DRM mechanisms, while effectively monitoring and managing license terms to enable lending of content in accordance with the fair use doctrine.

Upon initiating a transfer of content in accordance with block diagram 400 (e.g., via a user interface of a system or device coupled to license adjustor and content copier 430), content embodied within an original disk (e.g., 410) may be copied to produce a copy disk (e.g., 420). The limited license (e.g., 460) embodied within the copy disk may provide limited rights to a user of the copy disk as discussed above with respect to FIG. 1 (e.g., playback without copying, modifying, or otherwise transferring the content). While the limited license is active, the rights associated with content 440 may be reduced (e.g., to prevent playback, copying, modifying, etc.) to maintain the balance between enforcement of DRM mechanisms and the fair use doctrine (e.g., as described with respect to FIG. 1). The reduction of rights may be effectuated by license adjustor and content copier 430 altering the license associated with content 440 (e.g., adjustable license 450) when the original disk is accessible to the license adjustor and content copier (e.g., when the content is copied and/or when copy disk 420 is made).

Once the content on the copy disk is no longer accessible (e.g., the license to access the content has been deactivated as described with respect to step 150 of FIG. 1), the rights associated with content 440 given to a user of original disk 410 (e.g., as a purchaser of the content) may be restored (e.g., as described above with respect to step 160). The restoration of rights may be effectuated by license adjustor and content copier 430 altering the license associated with content 440 (e.g., adjustable license 450) when the original disk is accessible to the license adjustor and content copier (e.g., when a user attempts to access content 440 sometime after limited license 460 has been deactivated).

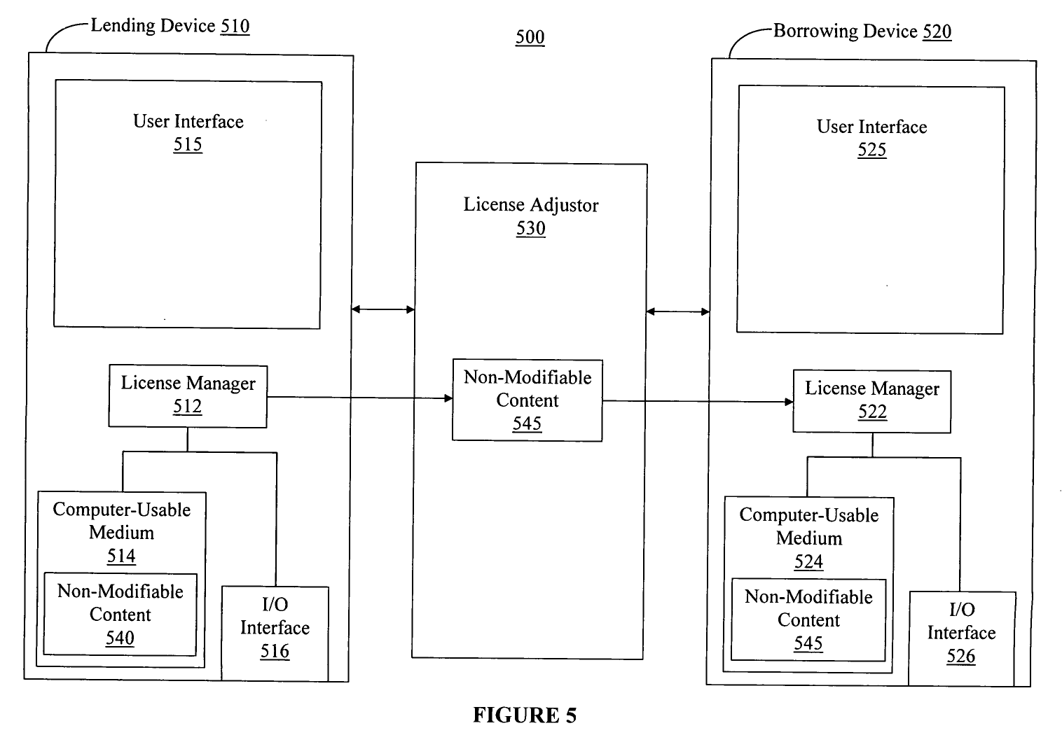

FIG. 5 shows block diagram 500 depicting the transfer of non-modifiable content from one device to another in accordance with one embodiment of the present invention. As shown in FIG. 5, lending device 510 and borrowing device 520 may transfer content similarly to lending device 310 and borrowing device 320, except that the content transferred in FIG. 5 (e.g., 540 and 545) is non-modifiable and does not require the transfer of an associated license (e.g., adjustable license 355 corresponding to content 345). As such, license management may be performed by license adjustor 530 similarly to that of license adjustor 330, except that license adjustor 530 communicates with license managers (e.g., 512 and 522) through the respective devices (e.g., 510 and 520) to adjust rights associated with content rather than through the alteration of licenses transferred with content (e.g., adjustable license 355 transferred with content 345).

Moreover, license managers (e.g., 512 and 522) provide DRM enforcement by monitoring access to and controlling the transfer of content to and from the lending and borrowing devices (e.g., through I/O interfaces 516 and 526). For example, as shown in FIG. 5, any content within the device (e.g. stored within or accessible by computer-usable medium 514) is transferred first through the license manager before exiting through I/O interface 516 or 526. In one embodiment, lending device 510 may be coupled to another computer system or device (e.g., borrowing device 520, license adjustor 530, etc.) via an interface (not shown) for transferring content and other data. Alternatively, borrowing device 520 may be coupled to another computer system or device (e.g., lending device 510, license adjustor 530, etc.) via an interface (not shown) for transferring content and other data. Accordingly, license managers may verify the authorization status of a recipient of the content prior to authorizing the transfer. Such an arrangement addresses the concern that content without an associated license (e.g., 540 and 545) may be accessed or used by an unauthorized user (e.g., someone other than a purchaser, owner, authorized borrower, etc.). Moreover, such an implementation may encourage compliance with license terms to carry out strong DRM mechanisms, while effectively monitoring and managing license terms to enable lending of content in accordance with the fair use doctrine.

Content 540 and content 545 may be any audio, video or audio/video content, which may be encoded and/or encrypted. As depicted in FIG. 5, the content (e.g. 540 and 545) may reside on computer-usable medium (e.g., 514 and 524). Computer-usable medium may be read-only memory inserted into the device (e.g., 510 and/or 520) such that the device may access content embodied thereon. Alternatively, computer-usable medium 514 and 524 may be a memory coupled to the device (e.g., hard disk drive, random access memory (RAM), flash drive, etc.).

Upon initiating a transfer of content in accordance with block diagram 500 (e.g., via user interface 515 or 525), content may be transferred from lending device 510 to borrowing device 520 as described above. In response to communication from license adjustor 530, license manager 522 may allow playback by borrowing device 520, but prevent copying, modifying, or otherwise transferring the content (e.g., as described with respect to step 140 of FIG. 1). While the content is accessible to borrowing device 520, the rights associated with content 540 accessible by lending device 510 may be reduced (e.g., to prevent playback, copying, modifying, etc.) to maintain the balance between enforcement of DRM mechanisms and the fair use doctrine (e.g., as described with respect to step 130 of FIG. 1). License manager 512 may reduce the rights associated with content 540 in response to communication from license adjustor 530, where these rights may be stored and accessed as data in a component or device coupled to license manager 512 and/or 522 (e.g., a memory in lending device 510, borrowing device 520, license adjustor 530, etc.). Additionally, although FIG. 5 depicts the transfer of content 545 through license adjustor 530, it should be appreciated that in other embodiments the content may not be transferred through the license adjustor (e.g., directly from lending device to borrowing device). Additionally, license adjustor 530 need only remain coupled to the devices (e.g., both devices simultaneously, one at a time, etc.) to the extent necessary to carry out its license management functions via the license managers as discussed previously.

Once the content is no longer accessible to borrowing device 520 (e.g., the license to access the content has been deactivated as described with respect to step 150 of FIG. 1), the rights associated with content 540 given to lending device 510 (e.g., as a purchaser of the content) may be restored (e.g., as described above with respect to step 160) by license manager 512. In the case where content 540 is transferred to borrowing device 520 such that access to content 540 is denied to lending device 510, the content may be returned to lending device 510 and borrowing device 520 may be denied access to the content thereafter by license manager 522 (e.g., by deleting the content, by rendering it inaccessible, etc.). Alternatively, where a copy of the content is transferred such that the lending device may still access the content while the borrowing device may access the copy, license adjustor 530 may deactivate the borrower's license (e.g., where such deactivation would not occur automatically as described above with respect to FIG. 1) by communicating with license manager 522 and restore the rights associated with the lender's content by communicating with license manager 512.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A method for managing rights associated with digital content, said method comprising:
accessing a first content segment;
generating a second content segment from said first content segment, wherein said second content segment is a reproduction of a portion of said first content segment;
limiting a plurality of rights associated with said first content segment upon activation of a license corresponding to said second content segment; and
restoring said plurality of rights associated with said first content segment upon deactivation of said license corresponding to said second content segment.

2. The method of claim 1, wherein said license corresponding to said second content segment permits playback and prevents copying of said second content segment.

3. The method of claim 1, wherein said limiting further comprises revoking the right to playback said first content segment.

4. The method of claim 1, wherein said digital content resides on a computer-usable medium.

5. The method of claim 4, wherein said computer-usable medium comprises non-volatile memory.

6. The method of claim 1, wherein said content resides within a memory of a portable computing device.

7. The method of claim 1, wherein said activation occurs upon a first access of said second content segment.

8. The method of claim 1, wherein said deactivation of said second content segment occurs at the expiration of a predetermined time period.

9. The method of claim 1, wherein said deactivation of said second content segment occurs at a predetermined time.

10. The method of claim 1, wherein said deactivation of said second content segment occurs after a predetermined number of accesses of said second content segment.

11. The method of claim 1, wherein said license and said second content segment both reside on a same computer-usable medium.

12. The method of claim 11, wherein said plurality of rights and said first content segment both reside on a same computer-usable medium.

13. A method for managing rights associated with a computer-usable medium containing digital content, said method comprising:
assigning a first license to said computer-usable medium, wherein said first license provides a plurality of rights to a first user of said computer-usable medium, and wherein said plurality of rights are associated with content on said computer-usable medium;
assigning a second license to said computer-usable medium in response to a transfer of said computer-usable medium to a second user, wherein said second license adjusts said plurality of rights; and
restoring said first license in response to a transfer of said computer-usable medium to said first user.

14. The method of claim 13, wherein said second license permits playback and prevents copying of said digital content.

15. The method of claim 13, wherein said computer-usable medium comprises non-volatile memory.

16. The method of claim 13, wherein said license and said second content segment both reside on a same computer-usable medium.

17. The method of claim 16, wherein said plurality of rights and said first content segment both reside on a same computer-usable medium.

18. A computer system comprising a processor coupled to a bus and a memory coupled to said bus, wherein said memory comprises instructions that when executed on said processor implement a method for managing rights associated with digital content, said method comprising:
accessing a first content segment;
generating a second content segment from said first content segment, wherein said second content segment is a reproduction of a portion of said first content segment;
limiting a plurality of rights associated with said first content segment upon activation of a license corresponding to said second content segment; and
restoring said plurality of rights associated with said first content segment upon deactivation of said license corresponding to said second content segment.

19. The system of claim 18, wherein said license corresponding to said second content segment permits playback and prevents copying of said second content segment.

20. The system of claim 18, wherein said limiting further comprises revoking the right to playback said first content segment.

21. The system of claim 18, wherein said digital content resides on a computer-usable medium.

22. The system of claim 21, wherein said computer-usable medium comprises non-volatile memory.

23. The system of claim 18, wherein said activation occurs upon a first access of said second content segment.

24. The system of claim 18, wherein said deactivation of said second content segment occurs at the expiration of a predetermined time period.

25. The system of claim 18, wherein said deactivation of said second content segment occurs at a predetermined time.

26. The system of claim 18, wherein said deactivation of said second content segment occurs after a predetermined number of accesses of said second content segment.

27. The system of claim 18, wherein said license and said second content segment both reside on a same computer-usable medium.

28. The system of claim 27, wherein said plurality of rights and said first content segment both reside on a same computer-usable medium.
